(19) United States
(12) Patent Application Publication
(10) Pub. No.: US 2026/0360618 A1
(43) Pub. Date: Nov. 12, 2026

(54) ASYMMETRIC SUCTION MAGNET AND MANUFACTURING METHOD THEREFOR, AND MAGNET ASSEMBLY

(71) Applicant: Muyang CHENG, Shenzhen, Guangdong (CN)

(72) Inventors: Wenhao CHENG, Shenzhen, Guangdong (CN); Muyang CHENG, Shenzhen, Guangdong (CN)

(21) Appl. No.: 19/103,095

(22) PCT Filed: Aug. 18, 2023
(86) PCT No.: PCT/CN2023/113776

§ 371 Date: Feb. 11, 2025

(30) Foreign Application Priority Data
May 8, 2023 (CN) 202310509682.8

(51) Int. Cl. H01F 41/02; B22F 3/15; B22F 3/24; H01F 7/02; H01F 13/00

(52) U.S. Cl. CPC H01F 41/0266; B22F 3/15; H01F 7/02; H01F 13/003; B22F 2003/248; B22F 2304/10; B22F 2998/10

(57) ABSTRACT

An asymmetric suction magnet and a manufacturing method therefor, and a magnet assembly, relating to the technical field of magnetic materials and magnet assemblies. The manufacturing method for an asymmetric suction magnet comprises the following steps: placing magnetic powder into a pressing die, and pressing the magnetic powder into a compact in a single-sided oriented magnetic field, wherein the single-sided oriented magnetic field means that in a die cavity of the pressing die, only one surface in the die cavity is provided with an oriented magnetic field; and carrying out post-treatment on the compact to obtain an asymmetric suction magnet. A special oriented pressing method is used to integrally form an asymmetric suction magnet, thereby achieving high manufacturing efficiency, and eliminating hidden dangers such as cracking in existing methods for manufacturing an asymmetric suction magnet.

### CROSS-REFERENCE TO RELATED APPLICATIONS

This application is a national stage application of PCT/CN2023/113776. The present disclosure claims priorities to PCT Application No. PCT/CN2023/113776, filed Aug. 18, 2023, and to Chinese Patent Application No. 202310509682.8 filed to the CNIPA on May 8, 2023, and entitled “ASYMMETRIC SUCTION MAGNET AND MANUFACTURING METHOD THEREFOR, AND MAGNET ASSEMBLY”, the disclosure of which are hereby incorporated by reference in its entirety.

### TECHNICAL FIELD

The present disclosure relates to the technical field of magnetic materials and magnet assemblies, and in particular to an asymmetric suction magnet and a manufacturing method therefor, and a magnet assembly.

### BACKGROUND

Magnetic materials are basic functional materials with extensive uses. Different industries have different requirements for magnets in terms of magnetic circuit structure, magnetic field intensity, magnetic field distribution, etc. In some industries, magnets or magnet assemblies are required to have as large suction as possible in a particular direction and as small suction as possible in the opposite direction. Such magnets are applied in fields such as magnetic buttons, magnetic luggage buckles, magnetic buttons for mobile phone protective cases, and magnetic buckles for iPAD protective cases. Such magnets are commonly called asymmetric suction magnets or assemblies (devices). HALBACH magnets are a kind of such assemblies.

The magnets, whose suction differ by more than one time between two suction surfaces, are usually called asymmetric suction magnets. For magnets with the same shape and size, the suction is directly proportional to the magnetic field intensity on the surface of the magnet. The higher the surface magnetic field intensity of the magnet is, the larger the suction is; and vice versa. To have asymmetric suction on the front and back surfaces of a magnet, the front and back surfaces of the magnet should have asymmetric magnetic field intensity. N poles and S poles on the front and back surfaces of a conventional magnet are symmetrically distributed. Generally, the surface magnetic field intensity on the front and back pole surfaces of the magnet are close, so the suction is also close. To have asymmetric surface magnetic field intensity on the front and back pole surfaces of a magnet, it is necessary to change the distribution of magnetic lines of force inside the magnet, i.e., the orientation inside the magnet, so that most of the magnetic lines of force in the magnet are centralized on a certain pole surface of the magnet, thereby increasing the suction of this pole surface and reducing the suction of the opposite pole surface.

At present, almost all methods for manufacturing asymmetric suction magnets are to machine magnet units with different orientation directions separately and then fasten the magnet units together with glue or fasteners according to the designed arrangement. For asymmetric suction magnet assemblies with large size and simple structure, such manufacturing methods are simple and fast. However, if asymmetric suction magnets or assemblies are small and have a large number of magnet units with different orientation directions, many difficulties will be encountered. For example, if a magnet assembly is small, the magnet units with different orientation directions cannot be fastened by fasteners; if the contact area between different oriented magnet units is small, there is a risk of cracking when the magnet units are bonded by an adhesive; and so on.

### SUMMARY

In view of this, the present disclosure provides an asymmetric suction magnet and a manufacturing method therefor, and a magnet assembly, wherein a special oriented pressing method is used to integrally form an asymmetric suction magnet, thereby achieving high manufacturing efficiency, and eliminating hidden dangers such as cracking in existing methods for manufacturing an asymmetric suction magnet.

For this purpose, the present disclosure mainly provides the following technical solutions.

In an aspect, an embodiment of the present disclosure provides a manufacturing method for an asymmetric suction magnet, including the following steps:
a pressing step: placing magnetic powder into a pressing die, and pressing the magnetic powder into a compact in a single-sided oriented magnetic field, wherein the single-sided oriented magnetic field means that in a die cavity of the pressing die, only one surface in the die cavity is provided with an oriented magnetic field, and the magnetic powder is magnetic powder used for sintering magnets; and
a post-treatment step: carrying out post-treatment on the compact to obtain an asymmetric suction magnet.

Preferably, the pressing die includes a die side plate, an upper punch and a lower punch, wherein the die cavity of the pressing die is surrounded by the die side plate, the upper punch and the lower punch; preferably, the die cavity has a plurality of surfaces, and the oriented magnetic field is arranged on one of the plurality of surfaces; and, further preferably, the die cavity has six surfaces.

Preferably, there is an odd number of poles in the oriented magnetic field; preferably, there is only one S pole or in the oriented magnetic field, or there is only one N pole in the oriented magnetic field; and, preferably, there are one S pole and two N poles in the oriented magnetic field, or there are one N pole and two S poles in the oriented magnetic field.

Preferably, there are at least two poles in the oriented magnetic field, and each pole is strip-shaped, wherein strip-shaped N poles and strip-shaped S poles are arranged in an alternating pattern in the oriented magnetic field.

Preferably, the oriented magnetic field is a grid oriented magnetic field, wherein the grid oriented magnetic field has a plurality of poles, the plurality of poles are arranged in a grid structure, and each pole serves as a grid unit; preferably, all the poles in the grid oriented magnetic field are S poles, or all the poles in the grid oriented magnetic field are N poles; and, preferably, the grid oriented magnetic field includes N poles and S poles, and grid units of the N poles and grid units of the S poles are arranged in an alternating pattern.

Preferably, the oriented magnetic field includes a plurality of poles, and the plurality of poles are arranged concentrically from inside to outside. Preferably, the oriented magnetic field includes at least one ring-shaped N pole and at least one ring-shaped S pole, and the ring-shaped N pole and the ring-shaped S pole are arranged in an alternating pattern. Preferably, the oriented magnetic field includes at least one ring-shaped pole and one circular pole, wherein the ring-shaped pole is arranged around the circular pole, and S poles and N poles in the oriented magnetic field are arranged in an alternating pattern. Preferably, the oriented magnetic field includes a plurality of ring-shaped poles which are arranged concentrically from inside to outside, wherein each ring-shaped pole is spliced by at least one arc-shaped N pole and at least one arc-shaped S pole, and the N poles and S poles in the oriented magnetic field are arranged in an alternating pattern; and, further preferably, each ring-shaped pole is spliced by two quarter arc-shaped N poles and two quarter arc-shaped S poles.

Preferably, the magnetic powder has a particle size of 2.0 to 6.0 μm.

Preferably, before the pressing step, the method further includes:
a step of manufacturing magnetic powder: melting raw materials into alloy according to the chemical components of the magnetic powder, and crushing and grinding the alloy into magnetic powder.

Preferably, the post-treatment step includes:
a step of vacuum sintering treatment and heat treatment: carrying out vacuum sintering treatment and heat treatment on the compact successively to obtain an asymmetric suction magnet blank;
preferably, the temperature for the vacuum sintering treatment is 1000 °C to 1200 °C; and, further preferably, the time for the vacuum sintering treatment is 2 to 4 hours;
preferably, the heat treatment includes first-stage heat treatment and second-stage heat treatment, wherein the temperature for the first-stage heat treatment is 850 °C to 950 °C, and the temperature for the second-stage heat treatment is 450 °C to 550 °C; and, further preferably, the time for the first-stage heat treatment is 2 to 4 hours, and the time for the second-stage heat treatment is 2 to 4 hours;
preferably, before the step of vacuum sintering, the method further includes:
a step of isostatic pressing treatment: carrying out isostatic pressing treatment on the compact to increase the density of the compact and reduce the deformation in a sintering stage, wherein, preferably, the isostatic pressing treatment is liquid isostatic pressing treatment or dry isostatic pressing treatment.

Preferably, the post-treatment step further includes:
a step of machining and magnetizing: machining the asymmetric suction magnet blank to a desired size, and magnetizing the asymmetric suction magnet blank to obtain an asymmetric suction magnet.

In another aspect, an embodiment of the present disclosure provides an asymmetric suction magnet, wherein the asymmetric suction magnet is of an integral structure; and preferably, the asymmetric suction magnet is manufactured by the above-described manufacturing method for an asymmetric suction magnet. Preferably, the asymmetric suction magnet has a first surface and a second surface which are opposite, and the surface magnetic field intensity of the first surface is more than two times of that of the second surface.

In still another aspect, an embodiment of the present disclosure provides a manufacturing method for an asymmetric suction magnet, wherein magnetic powder is pressed into a compact, and post-treatment is carried out on the compact to obtain an asymmetric suction magnet, wherein the magnetic powder is magnetic powder used for sintering magnets;
in a pressing step, the magnetic powder is placed into a pressing die, and pressed into a compact in a set double-sided oriented magnetic field, wherein the set double-sided oriented magnetic field means that there are two groups of oriented magnetic fields in a die cavity of the pressing die; the first group of oriented magnetic fields is arranged on a first surface of the die cavity, and the second group of oriented magnetic fields is arranged on a second surface of the die cavity; the first surface and the second surface are arranged oppositely; poles in the first group of oriented magnetic fields are first poles, and poles in the second group of oriented magnetic fields are second poles; the number of the first poles is the same as the number of the second poles, and the first poles correspond to the second poles one by one; and, the first poles have the same polarity as the second poles corresponding thereto, and the both are N poles or S poles;
wherein the degree of orientation of two surfaces of the compact in contact with the poles of the oriented magnetic field is greater than that at a middle position of the compact; at the middle position, the compact is cut into two parts along a plane parallel to the plane where the poles of the oriented magnetic field are located, or the compact is cut in any step of post-treatment, to eventually obtain an asymmetric suction magnet.

In yet another aspect, an embodiment of the present disclosure provides an asymmetric suction magnet, wherein the asymmetric suction magnet is of an integral structure; and preferably, the asymmetric suction magnet is manufactured by the above-described manufacturing method for an asymmetric suction magnet.

In yet another aspect, an embodiment of the present disclosure provides a magnet assembly, including the asymmetric suction magnet described above.

In addition, an embodiment of the present disclosure further provides a manufacturing method for an asymmetric suction bonded magnet, including the following steps:
a pressing step: placing anisotropic bonded magnetic powder into a pressing die, and pressing the anisotropic bonded magnetic powder into a compact in a single-sided oriented magnetic field, wherein the single-sided oriented magnetic field means that in a die cavity of the pressing die, only one surface in the die cavity is provided with an oriented magnetic field; and
baking: baking the compact to obtain an asymmetric suction bonded magnet.

In addition, an embodiment of the present disclosure further provides an asymmetric suction bonded magnet, which is manufactured by the above-described manufacturing method for an asymmetric suction bonded magnet.

In addition, an embodiment of the present disclosure provides a magnet assembly, including the asymmetric suction bonded magnet described above.

Compared with the prior art, the asymmetric suction magnet and manufacturing method therefor and the magnet assembly provided by the present disclosure have at least the following beneficial effects.

On one hand, the manufacturing method for an asymmetric suction magnet provided in the embodiments of the present disclosure firstly proposes that magnetic powder is pressed into a compact in a single-sided oriented magnetic field, and post-treatment is carried out on the compact to obtain an asymmetric suction magnet. Specifically, in the method of the present disclosure, only one surface in the die cavity is provided with an oriented magnetic field. Thus, the magnetic field at one end of the die cavity (the end close to the pole of the oriented magnetic field) is strong, and the magnetic lines of force near the pole are arranged approximately in parallel; and, the magnetic field at the other end (the end far away from the pole of the oriented magnetic field) is weak, and most of the magnetic lines of force are curved. Thus, the magnetic powder at the end close to the oriented magnetic field is arranged orderly and has a high degree of orientation, so that the magnetic performance of the magnet at this end is high; while the magnetic powder at the other end (the end far away from the oriented magnetic field) has a low degree of orientation, so that the magnetic performance of the magnet at this end is low. Therefore, in the single-sided oriented magnetic field proposed in the present disclosure, the magnetic powder is pressed into a compact, and post-treatment is carried out on the compact to obtain an asymmetric suction magnet. This is a concept proposed by the present disclosure for the first time, which has never been proposed in the prior art.

Further, in the manufacturing method for an asymmetric suction magnet provided in the embodiments of the present disclosure, a plurality of poles in a single-sided oriented magnetic field are arranged in any shape of strips, rings and grids. Different arrangement modes are suitable for the production of magnets and assemblies with different uses or shapes. For example, the strip arrangement is suitable for the production of rectangular magnets with small dimensions in a strip direction. During production, the dimensions of a pressing die in other two directions are designed according to the requirements, and the dimension in the strip direction can be very long. After the blank is produced, the blank is cut into multiple sections, and many rectangular small magnetic sheets can be machined from a strip-shaped magnet. For example, the ring arrangement suitable for the production of ring-shaped magnets and assemblies (e.g., magnetic buttons). The grid arrangement is suitable for the production of square magnets or assemblies. During production, a larger square magnet can be produced and then cut into a plurality of smaller square sheets. The above arrangement modes are considered to improve production efficiency.

On the other hand, in the manufacturing method for an asymmetric suction magnet provided in the embodiments of the present disclosure, in the pressing step proposed for the first time, magnetic power is placed into a pressing die, and pressed into a compact in a set double-sided oriented magnetic field, wherein the set double-sided oriented magnetic field means that there are two groups of oriented magnetic fields in a die cavity of the pressing die, wherein the first group of oriented magnetic fields is arranged on a first surface of the die cavity, and the second group of oriented magnetic fields is arranged on a second surface of the die cavity; the first surface and the second surface are arranged oppositely; poles in the first group of oriented magnetic fields are first poles, and poles in the second group of oriented magnetic fields are second poles; the number of the first poles is the same as the number of the second poles, and the first poles correspond to the second poles one by one; and, the first poles have the same polarity as the second poles corresponding thereto, and the both are N poles or S poles (unlike the prior art, although a double-sided oriented magnetic field is also used in the prior art, in the double-sided oriented magnetic field in the prior art, the first poles have the opposite polarity as the corresponding second poles). The degree of orientation at two ends of the compact is greater than that at a middle position of the compact. It is equivalent that two oriented magnetic fields each serve as one single-sided oriented magnetic field. A magnet manufactured by oriented magnetic fields in this mode can become two asymmetric suction magnets if it is divided into two parts from the middle.

To sum up, the asymmetric suction magnet manufactured by the method provided in the embodiments of the present disclosure is of an integral structure, and is not spliced as in the prior art. Moreover, the method of the present disclosure has high manufacturing efficiency, and eliminates hidden dangers such as cracking in existing methods for manufacturing an asymmetric suction magnet.

The foregoing description merely shows the overview of the technical solutions of the present disclosure. To understand the technical means of the present disclosure more clearly and implement the present disclosure according to the contents in this specification, the preferred embodiments of the present disclosure will be described below in detail with reference to the accompanying drawings.

### BRIEF DESCRIPTION OF THE DRAWINGS

FIG. 1 is a schematic diagram of the single-sided oriented magnetic field provided in the pressing die according to the present disclosure;

FIG. 2 is a schematic diagram of the arrangement of poles in the oriented magnetic field in a strip manner according to the present disclosure;

FIG. 3 is a schematic diagram of the arrangement of poles in the oriented magnetic field in a grid manner according to the present disclosure;

FIG. 4 is a schematic diagram of the arrangement of poles in the oriented magnetic field in a ring manner according to the present disclosure;

FIG. 5 is another schematic diagram of the arrangement of poles in the oriented magnetic field in a ring manner according to the present disclosure;

FIG. 6 is another schematic diagram of the arrangement of poles in the oriented magnetic field in a ring manner according to the present disclosure;

FIG. 7 is a schematic diagram of two groups of oriented magnetic fields provided in the pressing die according to the present disclosure; and

FIG. 8 is a schematic diagram of the grid single-sided oriented magnetic field with 4 poles provided in the pressing die according to the present disclosure.

### DETAILED DESCRIPTION OF THE INVENTION

To further explain the technical means used to achieve the intended disclosure objective and the effects thereof in the present disclosure, the specific implementations, structures, features and effects of the present disclosure will be described below in detail by preferred embodiments with reference to the accompanying drawings. In the following description, different “one embodiment” or “embodiments” do not necessarily refer to the same embodiment. In addition, particular features, structures or characteristics in one or more embodiments can be combined in any proper way.

The objective of the present disclosure is to overcome “the difficulties and deficiencies in the manufacturing process of asymmetric suction magnets, particularly small asymmetric suction magnets or assemblies” mentioned in the prior art.

In the scheme of the present disclosure, instead of “machining magnet units, and fastening the magnet units together by physical methods (e.g., bonding by an adhesive)” as mentioned in the BACKGROUND, a special oriented pressing method is used, and integrated modeling is adopted for manufacturing. Therefore, the scheme of the present disclosure has high manufacturing efficiency and eliminates hidden dangers such as cracking.

Here, the main inventive concept of the present disclosure is analyzed and explained as below:

The magnetic performance of the magnet is closely related to the magnitude and direction of the oriented magnetic field in the process of molding magnetic powder. If the oriented magnetic field in the die is high and ordered, the degree of orientation of the magnetic powder is high, and the magnetic performance of the magnet is high, then the surface magnetic field intensity of the magnet of the same specification and size is high, and the suction is large. If the oriented magnetic field in the die is weak, the degree of orientation of the magnetic powder is low, and the magnetic performance of the final magnet is low, then the surface magnetic field intensity of the magnet of the same specification and size is low, and the suction is small. In the prior art, it is required that the magnetic performance of the whole magnet should be high and uniform. In the process of molding magnetic powder, by providing a uniform parallel magnetic field (that is, all magnetic powder is located in a parallel magnetic field), the magnetic performance of the manufactured magnet is uniform, and the magnetic performance of any part of the magnet is very close. Compared with the prior art, in the present disclosure, by specially providing a non-uniform magnetic field in the die, different surfaces of the magnetic powder in the die are different in the degree of orientation, so that a magnet with different magnetic performances on its two opposite surfaces (i.e., front and back surfaces), i.e., an asymmetric suction magnet, is produced.

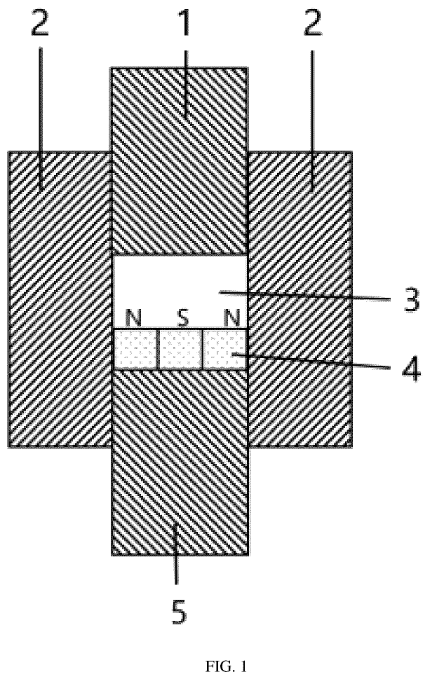

The first concept of the present disclosure is shown in FIG. 1. In the present disclosure, magnetic powder is pressed into a compact in a single-sided oriented magnetic field, and post-treatment is carried out on this compact to obtain an asymmetric suction magnet. As shown in FIG. 1, only one surface in the die cavity is provided with an oriented magnetic field, so that the magnetic field on the oriented magnetic field surface of the die cavity is strong, and the magnetic lines of force are arranged approximately in parallel near the pole surface of the oriented magnetic field; while the distance away from the pole surface is larger, the magnetic field intensity is lower, and the magnetic lines of force are less parallel. Thus, the degree of orientation of the magnetic powder on the side close to the oriented magnetic field is higher, the magnetic performance is higher; while the degree of orientation of the magnetic powder on the side away from the oriented magnetic field is lower, the magnetic performance is lower. Therefore, in the single-sided oriented magnetic field, the magnetic powder is pressed into a compact, and post-treatment is carried out on the compact to obtain an asymmetric suction magnet.

Here, in view of the first concept proposed by the present disclosure, the present disclosure provides a manufacturing method for a asymmetric suction magnet, as shown in FIG. 1, including the following steps.

In a step of manufacturing magnetic powder, raw materials are melted into alloy according to the chemical components of magnetic powder, and the alloy is crushed and grinded into magnetic powder.

The magnetic powder has a particle size of 2.0 to 6.0 μm.

In a pressing step, the magnetic powder is placed into a pressing die, and the magnetic powder is pressed into a compact in a single-sided oriented magnetic field, wherein the single-sided oriented magnetic field means that in a die cavity 3 of the pressing die, only one surface in the die cavity is provided with an oriented magnetic field 4.

In this step, as shown in FIG. 1, the pressing die includes a die side plate 2, an upper punch 1 and a lower punch 5, wherein the die cavity 3 of the pressing die is surrounded by the die side plate 2, the upper punch 1 and the lower punch 5. The die cavity 3 has a plurality of surfaces, and the oriented magnetic field 4 is arranged on one of the plurality of surfaces. Further preferably, the die cavity 3 has six surfaces (the die cavity has an upper surface, a lower surface, a left surface, a right surface, a front surface and a rear surface, and the oriented magnetic field 4 may be arranged on any surface).

In addition, the arrangement of poles in the oriented magnetic field can satisfy at least one of the following characteristics: (1) there may be an odd number of poles in the oriented magnetic field, e.g., only one S pole or one N pole, or one S pole and two N poles, etc.; and, (2) if there are two or more different poles in the oriented magnetic field, N poles and S poles are arranged in an alternating pattern.

Specifically, the arrangement of poles in the single-sided oriented magnetic field in the present disclosure can adopt the following modes.

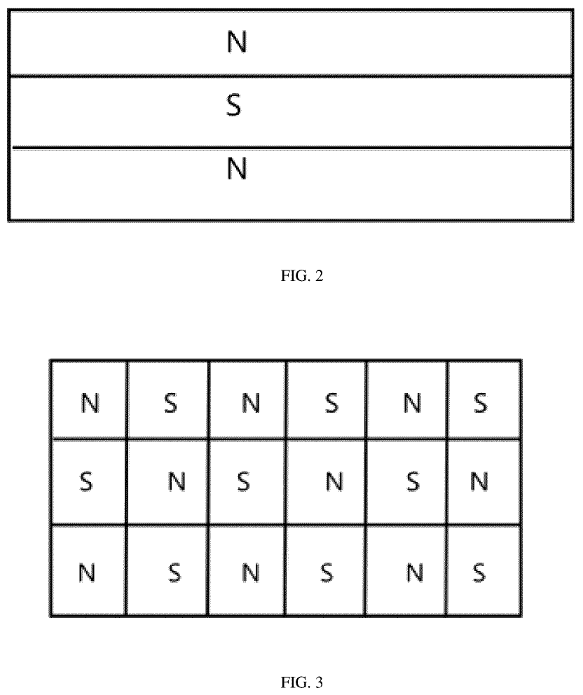

In the first mode, as shown in FIG. 2, the poles in the oriented magnetic field are arranged in a strip manner: the oriented magnetic field has at least two poles, and each pole is strip-shaped, wherein strip-shaped N poles and strip-shaped S poles in the oriented magnetic field are arranged in an alternating pattern.

In the second mode, the poles in the oriented magnetic field are arranged in a grid manner:
the oriented magnetic field is a grid oriented magnetic field, wherein the grid oriented magnetic field has a plurality of poles, the plurality of poles are arranged into a grid structure, and each pole serves as one grid unit.

In one grid arrangement mode, all the poles in the grid oriented magnetic field are S poles, or all the poles in the grid oriented magnetic field are N poles.

In another grid arrangement mode, as shown in FIG. 3, the grid oriented magnetic field includes N poles and S poles, and grid units of the N poles and grid units of the S poles are arranged in an alternating pattern.

In the third mode, the poles in the oriented magnetic field are arranged in a ring manner:
the oriented magnetic field includes a plurality of poles, and the plurality of poles are arranged concentrically from inside to outside. On this basis, there are several following ring arrangement modes.

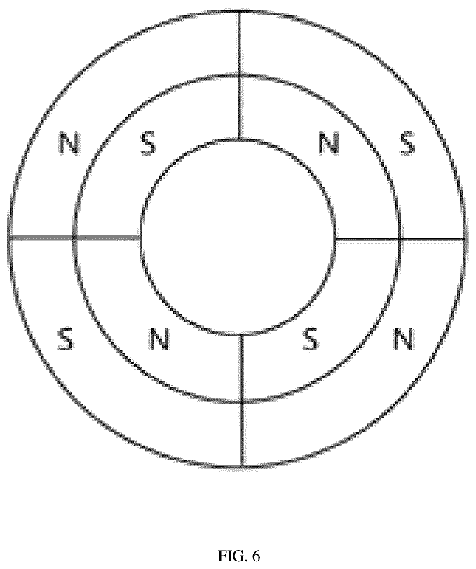

In one ring arrangement mode, as shown in FIG. 5, the oriented magnetic field includes at least one ring-shaped N pole and at least one ring-shaped S pole, and the ring-shaped N pole and the ring-shaped S pole are arranged in an alternating pattern.

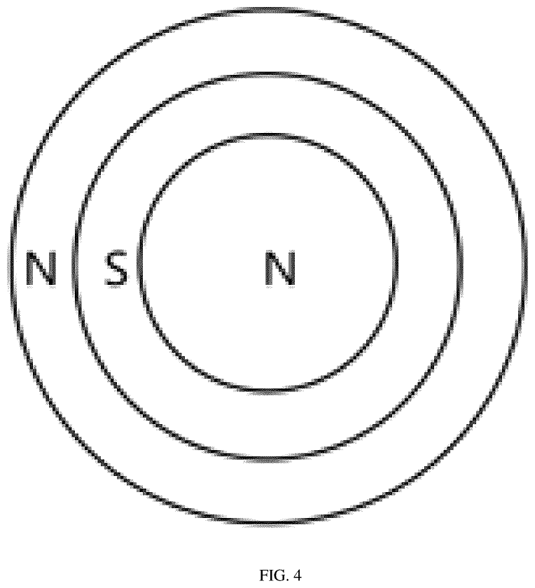

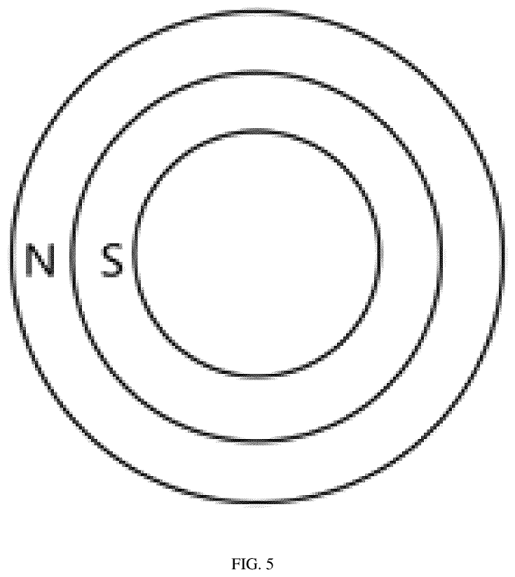

In another arrangement mode, as shown in FIG. 4, the oriented magnetic field includes at least one ring-shaped pole and one circular pole, wherein the ring-shaped pole is arranged around the circular pole (when there is a plurality of ring-shaped poles, the plurality of ring-shaped poles are sequentially arranged around the circular pole from inside to outside), and S poles and N poles are arranged in an alternating pattern.

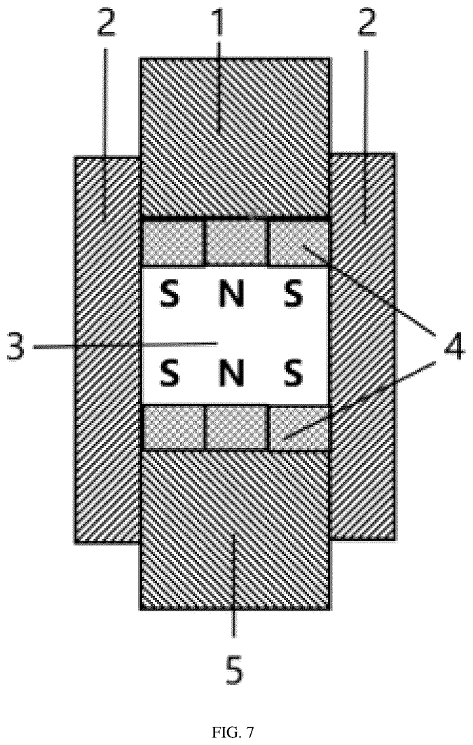

In still another arrangement mode, as shown in FIG. 6, the oriented magnetic field includes a plurality of ring-shaped poles which are arranged concentrically from inside to outside, wherein each ring-shaped pole is spliced by at least one arc-shaped N pole and at least one arc-shaped S pole, and the N poles and S poles in the oriented magnetic field are arranged in an alternating pattern. Further preferably, each ring-shaped pole is spliced by two quarter arc-shaped N poles and two quarter arc-shaped S poles.

Preferably, the pressing step includes: placing the magnetic powder into the die cavity of the pressing die (press die), and generating a magnetic field by the single-sided oriented magnetic field; and, after the intensity of the single-sided oriented magnetic field reaches the set value, keeping the lower punch unmoved and moving the upper punch down, or keeping the upper punch unmoved and moving the lower punch up, or moving the upper punch and the lower punch toward the center of the die cavity, to apply pressure to the magnetic powder until the magnetic powder becomes a compact.

In a post-treatment step, post-treatment is carried out on the compact to obtain an asymmetric suction magnet.

Here, the post-treatment step includes a step of isostatic pressing treatment, a step of vacuum sintering and heat treatment, and a step of machining and magnetizing.

In the step of isostatic pressing treatment, isostatic pressing treatment is carried out on the compact to increase the density of the compact and reduce the deformation in a sintering stage. Preferably, the isostatic pressing treatment is liquid isostatic pressing treatment or dry isostatic pressing treatment. Preferably, the step of isostatic pressing treatment includes: placing the compact into a plastic bag, vacuuming, thermally sealing the plastic bag, and putting the plastic bag into an isostatic pressing machine for isostatic pressing at 150 to 250 Mpa.

In the step of vacuum sintering treatment and heat treatment, vacuum sintering treatment and heat treatment are carried out on the compact successively to obtain an asymmetric suction magnet blank.

Preferably, the temperature for the vacuum sintering treatment is 1000 °C to 1200 °C.

Preferably, the heat treatment includes first-stage heat treatment and second-stage heat treatment, wherein the temperature for the first-stage heat treatment is 850 °C to 950 °C, and the temperature for the second-stage heat treatment is 450 °C to 550 °C.

In the step of machining and magnetizing, the asymmetric suction magnet blank is machined to a desired size, and the asymmetric suction magnet blank is magnetized to obtain an asymmetric suction magnet.

Regarding the magnetizing in the present disclosure, it is to be noted that the method of magnetizing the asymmetric function magnet is a common magnetizing method. For example, the method of magnetizing the asymmetric suction magnet manufactured by the single-sided oriented magnetic field as shown in FIG. 1 is as follows. A magnetizing clamp that can produce three poles on each of the upper and lower surfaces is prepared. If the poles produced on the upper surface are N poles, the poles produced on the corresponding lower surface are S poles. Similarly, the S poles on the upper surface correspond to the N poles on the lower surface. The magnet is clipped between two magnetizing poles. If a pulse magnetic field is formed between the upper and lower poles, this asymmetric suction magnet will be magnetized.

In addition, the present disclosure further provides an asymmetric suction magnet, which is manufactured by any one of the above-described manufacturing methods for an asymmetric suction magnet. One surface of the asymmetric suction magnet of the present disclosure has high surface magnetic field intensity and large suction, and the other surface (opposite surface) has low surface magnetic field intensity and small suction.

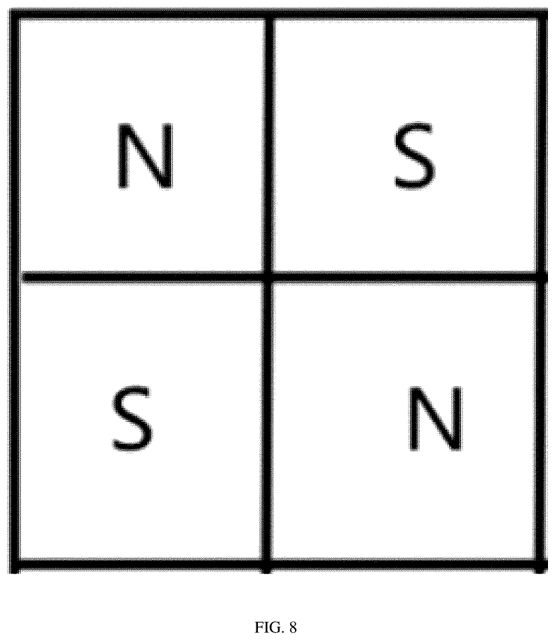

In addition, the present disclosure also proposes a second inventive concept. As shown in FIG. 7, the manufacturing method for an asymmetric suction magnet in the second inventive concept differs from the first inventive concept in that:

As shown in FIG. 7, in a pressing step, magnetic power is placed into a pressing die, and pressed into a compact in a set double-sided oriented magnetic field, wherein the set double-sided oriented magnetic field means that there are two groups of oriented magnetic fields in a die cavity of the pressing die, wherein the first group of oriented magnetic fields is arranged on a first surface of the die cavity, and the second group of oriented magnetic fields is arranged on a second surface of the die cavity; the first surface and the second surface are arranged oppositely; poles in the first group of oriented magnetic fields are first poles, and poles in the second group of oriented magnetic fields are second poles; the number of the first poles is the same as the number of the second poles, and the first poles correspond to the second poles one by one; and, the first poles have the same polarity as the second poles corresponding thereto, and the both are N poles or S poles (it is to be noted that, unlike the prior art, although a double-sided oriented magnetic field is also used in the prior art, in the double-sided oriented magnetic field in the prior art, the first poles have the opposite polarity as the corresponding second poles). The degree of the surface of the compact close to the poles is greater than that at the middle position of the compact.

In the second inventive concept, the double-sided oriented magnetic field shown in FIG. 7 is used for pressing. At the middle portion, the compact is cut into two parts along the plane parallel to the plane where the poles of the oriented magnetic field are located, or the compact is cut in any step of post-treatment, thus eventually obtaining two asymmetric suction magnets.

In the second inventive concept, the arrangement of poles in the oriented magnetic field on each surface and the processes such as post-treatment can refer to those in the first inventive concept and will not be repeated here.

Here, the principle of the second inventive concept will be explained below. The corresponding first poles and second poles are of the same pole type, so the first oriented magnetic field and the second oriented magnetic field that are arranged oppositely are mutually repulsive. Thus, the magnetic powder at the end of the first oriented magnetic field in the die cavity has a high degree of orientation, the magnetic powder at the end close to the second oriented magnetic field has a high degree of orientation, and the magnetic power between the two ends has a low degree of orientation. It is equivalent that two oriented magnetic fields each serve as one single-sided oriented magnetic field. A magnet manufactured by oriented magnetic fields in this mode can become two asymmetric suction magnets if it is divided into two parts from the middle.

The above schemes (two inventive concepts) of the present disclosure are mainly schemes for manufacturing an asymmetric suction magnet from magnetic powder used for sintering magnets. In fact, the above inventive concepts of the present disclosure are also suitable for manufacturing asymmetric suction bonded magnets from anisotropic bonded magnetic powder (e.g., anisotropic NdFeB bonded magnetic powder, anisotropic SmCo bonded magnetic powder, anisotropic SmFeN bonded magnetic powder, etc.) by adopting a baking step (the baking temperature is 150 °C to 300 °C) in the post-treatment step, without sintering and heat treatment.

The present disclosure will be further described below in detail by specific embodiments.

### Embodiment 1

In this embodiment, an asymmetric suction magnet is manufactured mainly by the following steps:
1) NdFeB alloy was smelted according to the following formulation (by weight percentage): 32.5% of PrNd, 0.5% of Dy, 0.92% of B and 66.08% of Fe. The obtained NdFeB alloy was subjected to coarse crushing and airflow milling to obtain magnetic powder having a particle size of 3 to 4 μm.
2) A single-sided oriented magnetic field die with three strip-shaped poles arranged as shown in FIG. 1 was prepared, where the arrangement of the magnetic field 4 is shown in FIG. 2, and the area of the upper and lower punches of the die and the area of the single-sided oriented magnetic field were 30 mm×30 mm, respectively.
3) 25 g of the magnetic powder was placed into a die cavity 3 of the pressing die (press die) shown in FIG. 1, and a magnet field>8000 Gs was formed at poles of the single-sided oriented magnetic field 4, and the upper punch 1 was moved down while keeping the lower punch 5 unmoved, to apply pressure to the magnetic powder until the magnetic powder became a compact.
4) Isostatic pressing treatment was carried on the compact at 180 Mpa to continuously improve the density.
5) The compact after isostatic pressing was sintered in vacuum for 3 hours at 1065 °C, then subjected to first-stage heat treatment for 2 hours at 900 °C, and subjected to second-stage heat treatment for 3 hours at 500 °C to obtain an asymmetric suction magnet blank.
6) The black skin and raised part of the asymmetric suction magnet blank were grinded by a flat grinder to obtain a sheet magnet.
7) The sheet magnet obtained in the step (6) was placed in a magnetizing clamp with three poles on each of its upper and lower surfaces, wherein the arrangement of the poles in the magnetizing clamp was as follows: if the poles produced on the upper surface were N poles, the poles produced on the corresponding lower surface were S poles; and similarly, the S poles on the upper surface corresponded to the N poles on the lower surface. A pulse magnetic field was formed between the upper and lower poles by a magnetizing machine to magnetize the asymmetric suction magnet.
8) The highest surface magnetic field intensity of the three poles on the front and back surfaces was detected by a gauss meter. During molding, the highest surface magnetic field intensity on the surface close to the single-sided oriented magnetic field was greater than 2800 Gs, the highest surface magnetic field intensity on the opposite surface was less than 600 Gs, and the two surfaces differed by more than 4 times in the surface magnetic field intensity.

In the magnet manufactured in this embodiment, the first end face (one end face) of the magnet is closed to the oriented magnetic field in the pressing process, while the second end face (the other end face) is away from the oriented magnetic field in the pressing process. The magnetic field intensity of the first end face of the magnet is more than 4 times of that of the second end face. The test proves that the thicker the magnet is, the larger the difference in the magnetic field intensity between the two end faces is.

### Embodiment 2

1) NdFeB alloy was smelted according to the following formulation (by weight percentage): 32.5% of PrNd, 0.5% of Dy, 0.92% of B and 66.08% of Fe. The obtained NdFeB alloy was subjected to coarse crushing and airflow milling to obtain magnetic powder having a particle size of 3 to 4 μm.
2) A grid single-sided oriented magnetic field in 30 mm×30 mm composed of two N poles and two S poles as shown in FIG. 8 was prepared.
3) The single-sided oriented magnetic field in FIG. 1 was replaced with the grid magnetic field shown in FIGS. 8, 25 g of the magnetic powder was placed into a die cavity 3 of the pressing die (press die) shown in FIG. 1, and a magnet field>8000 Gs was formed at poles of the single-sided oriented magnetic field 8, and the upper punch 1 was moved down while keeping the lower punch 5 unmoved, to apply pressure to the magnetic powder until the magnetic powder became a compact.
4) Isostatic pressing treatment was carried on the compact at 180 Mpa to continuously improve the density.
5) The compact after isostatic pressing was sintered in vacuum for 3 hours at 1065 °C, then subjected to first-stage heat treatment for 2 hours at 900 °C, and subjected to second-stage heat treatment for 3 hours at 500 °C to obtain an asymmetric suction magnet blank.
6) The black skin and raised part of the asymmetric suction magnet blank were grinded by a flat grinder to obtain a sheet magnet.
7) The sheet magnet obtained in the step (6) was placed in a magnetizing clamp with four poles on each of its upper and lower surfaces, wherein the arrangement of the poles in the magnetizing clamp was as follows: if the poles produced on the upper surface were N poles, the poles produced on the corresponding lower surface were S poles; and similarly, the S poles on the upper surface corresponded to the N poles on the lower surface. A pulse magnetic field was formed between the upper and lower poles by a magnetizing machine to magnetize the asymmetric suction magnet.
8) The highest surface magnetic field intensity of the three poles on the front and back surfaces was detected by a gauss meter. During molding, the highest surface magnetic field intensity on the surface close to the single-sided oriented magnetic field was greater than 2500 Gs, the highest surface magnetic field intensity on the opposite surface was less than 600 Gs, and the two surfaces differed by more than 4 times in the surface magnetic field intensity.

### Embodiment 3

1) NdFeB alloy was smelted according to the following formulation (by weight percentage): 32.5% of PrNd, 0.5% of Dy, 0.92% of B and 66.08% of Fe. The obtained NdFeB alloy was subjected to coarse crushing and airflow milling to obtain magnetic powder having a particle size of 3 to 4 μm.
2) A die as shown in FIG. 7 was prepared, wherein the double-sided oriented magnetic field 4 was single-sided oriented magnetic field with three strip-shaped poles arranged as shown in FIG. 2, and the area of the upper and lower punches and the area of the oriented magnetic field were 30 mm×30 mm, respectively.
3) 50 g of the magnetic powder was placed into a die cavity 3 of the pressing die (press die) shown in FIG. 7, and a magnet field>8000 Gs was formed at poles of the single-sided oriented magnetic field 4, and the upper punch 1 was moved down while keeping the lower punch 5 unmoved, to apply pressure to the magnetic powder until the magnetic powder became a compact.
4) Isostatic pressing treatment was carried on the compact at 180 Mpa to continuously improve the density.
5) The compact after isostatic pressing was sintered in vacuum for 3 hours at 1065 °C, then subjected to first-stage heat treatment for 2 hours at 900 °C, and subjected to second-stage heat treatment for 3 hours at 500 °C to obtain an asymmetric suction magnet blank.
6) The black skin and raised part of the asymmetric suction magnet blank were grinded by a flat grinder to obtain a sheet magnet.
7) The sheet magnet obtained in the step (6) was cut into two parts along its thickness direction by a wire, so as to obtain two magnets.
8) The sheet magnets obtained in the step (7) were magnetized by the magnetizing method in Embodiment 1.
9) The highest surface magnetic field intensity of the three poles on the front and back surfaces was detected by a gauss meter. During molding, the highest surface magnetic field intensity on the surface close to the single-sided oriented magnetic field was greater than 2600 Gs, the highest surface magnetic field intensity on the opposite surface was less than 600 Gs, and the two surfaces differed by more than 4 times in the surface magnetic field intensity.

To sum up, in the asymmetric suction magnet and the manufacturing method therefor, and the magnet assembly provided in the embodiments of the present disclosure, a special oriented pressing method is used to integrally form an asymmetric suction magnet, thereby achieving high manufacturing efficiency, and eliminating hidden dangers such as cracking in existing methods for manufacturing an asymmetric suction magnet.

The foregoing description merely shows preferred embodiments of the present disclosure and is not intended to limit the present disclosure in any form. Any simple modification, equivalent alteration and modification made to these embodiments according to the technical essence the present disclosure shall fall into the scope of the technical solutions of the present disclosure.

1. A manufacturing method for an asymmetric suction magnet, comprising the following steps:
a pressing step: placing magnetic powder into a pressing die, and pressing the magnetic powder into a compact in a single-sided oriented magnetic field, wherein the single-sided oriented magnetic field means that in a die cavity of the pressing die, only one surface in the die cavity is provided with an oriented magnetic field, and the magnetic powder is magnetic powder used for sintering magnets; and
a post-treatment step: carrying out post-treatment on the compact to obtain an asymmetric suction magnet.

2. The manufacturing method for an asymmetric suction magnet according to claim 1, wherein the pressing die comprises a die side plate, an upper punch and a lower punch, wherein,
the die cavity of the pressing die is surrounded by the die side plate, the upper punch and the lower punch; and
preferably, the die cavity has a plurality of surfaces, and the oriented magnetic field is arranged on one of the plurality of surfaces; and, further preferably, the die cavity has six surfaces.

3. The manufacturing method for an asymmetric suction magnet according to claim 1, wherein there is an odd number of poles in the oriented magnetic field;
preferably, there is only one S pole or in the oriented magnetic field, or there is only one N pole in the oriented magnetic field; and
preferably, there are one S pole and two N poles in the oriented magnetic field, or there are one N pole and two S poles in the oriented magnetic field.

4. The manufacturing method for an asymmetric suction magnet according to claim 1, wherein there are at least two poles in the oriented magnetic field, and each pole is strip-shaped, wherein strip-shaped N poles and strip-shaped S poles are arranged in an alternating pattern in the oriented magnetic field.

5. The manufacturing method for an asymmetric suction magnet according to claim 1, wherein the oriented magnetic field is a grid oriented magnetic field, wherein the grid oriented magnetic field has a plurality of poles, the plurality of poles are arranged in a grid structure, and each pole serves as a grid unit;
preferably, all the poles in the grid oriented magnetic field are S poles, or all the poles in the grid oriented magnetic field are N poles; and
preferably, the grid oriented magnetic field comprises N poles and S poles, and grid units of the N poles and grid units of the S poles are arranged in an alternating pattern.

6. The manufacturing method for an asymmetric suction magnet according to claim 1, wherein the oriented magnetic field comprises a plurality of poles, and the plurality of poles are arranged concentrically from inside to outside;
preferably, the oriented magnetic field comprises at least one ring-shaped N pole and at least one ring-shaped S pole, and the ring-shaped N pole and the ring-shaped S pole are arranged in an alternating pattern;
preferably, the oriented magnetic field comprises at least one ring-shaped pole and one circular pole, wherein the ring-shaped pole is arranged around the circular pole, and S poles and N poles in the oriented magnetic field are arranged in an alternating pattern; and
preferably, the oriented magnetic field comprises a plurality of ring-shaped poles which are arranged concentrically from inside to outside, wherein each ring-shaped pole is spliced by at least one arc-shaped N pole and at least one arc-shaped S pole, and the N poles and S poles in the oriented magnetic field are arranged in an alternating pattern; and, further preferably, each ring-shaped pole is spliced by two quarter arc-shaped N poles and two quarter arc-shaped S poles.

7. The manufacturing method for an asymmetric suction magnet according to claim 1, wherein the magnetic powder has a particle size of 2.0 to 6.0 μm; and/or
before the pressing step, the method further comprises:
a step of manufacturing magnetic powder: melting raw materials into alloy according to the chemical components of the magnetic powder, and crushing and grinding the alloy into magnetic powder.

8. The manufacturing method for an asymmetric suction magnet according to claim 1, wherein the post-treatment step comprises:
a step of vacuum sintering treatment and heat treatment: carrying out vacuum sintering treatment and heat treatment on the compact successively to obtain an asymmetric suction magnet blank;
preferably, the temperature for the vacuum sintering treatment is 1000 °C to 1200 °C; and, further preferably, the time for the vacuum sintering treatment is 2 to 4 hours;
preferably, the heat treatment comprises first-stage heat treatment and second-stage heat treatment, wherein the temperature for the first-stage heat treatment is 850 °C to 950 °C, and the temperature for the second-stage heat treatment is 450 °C to 550 °C; and, further preferably, the time for the first-stage heat treatment is 2 to 4 hours, and the time for the second-stage heat treatment is 2 to 4 hours;
preferably, before the step of vacuum sintering, the method further comprises:
a step of isostatic pressing treatment: carrying out isostatic pressing treatment on the compact to increase the density of the compact and reduce the deformation in a sintering stage, wherein, preferably, the isostatic pressing treatment is liquid isostatic pressing treatment or dry isostatic pressing treatment.

9. The manufacturing method for an asymmetric suction magnet according to claim 8, wherein the post-treatment step further comprises:
a step of machining and magnetizing: machining the asymmetric suction magnet blank to a desired size, and magnetizing the asymmetric suction magnet blank to obtain an asymmetric suction magnet.

10. An asymmetric suction magnet, wherein the asymmetric suction magnet is of an integral structure; and preferably, the asymmetric suction magnet is manufactured by the manufacturing method for an asymmetric suction magnet according to claim 1; and
preferably, the asymmetric suction magnet has a first surface and a second surface which are opposite, and the surface magnetic field intensity of the first surface is more than two times of that of the second surface.

11. A manufacturing method for an asymmetric suction magnet, wherein magnetic powder is pressed into a compact, and post-treatment is carried out on the compact to obtain an asymmetric suction magnet, wherein,
in a pressing step, the magnetic powder is placed into a pressing die, and pressed into a compact in a set double-sided oriented magnetic field, wherein the set double-sided oriented magnetic field means that there are two groups of oriented magnetic fields in a die cavity of the pressing die; the first group of oriented magnetic fields is arranged on a first surface of the die cavity, and the second group of oriented magnetic fields is arranged on a second surface of the die cavity; the first surface and the second surface are arranged oppositely; poles in the first group of oriented magnetic fields are first poles, and poles in the second group of oriented magnetic fields are second poles; the number of the first poles is the same as the number of the second poles, and the first poles correspond to the second poles one by one; the first poles have the same polarity as the second poles corresponding thereto, and the both are N poles or S poles; and, the magnetic powder is magnetic powder used for sintering magnets;
wherein the degree of orientation of two surfaces of the compact in contact with the poles of the oriented magnetic field is greater than that at a middle position of the compact; at the middle position, the compact is cut into two parts along a plane parallel to the plane where the poles of the oriented magnetic field are located, or the compact is cut in any step of post-treatment, to eventually obtain an asymmetric suction magnet.

12. An asymmetric suction magnet, wherein the asymmetric suction magnet is of an integral structure; and preferably, the asymmetric suction magnet is manufactured by the manufacturing method for an asymmetric suction magnet according to claim 11.

13. A magnet assembly, comprising the asymmetric suction magnet according to claim 10.

14. A manufacturing method for an asymmetric suction bonded magnet, comprising the following steps:
a pressing step: placing anisotropic bonded magnetic powder into a pressing die, and pressing the anisotropic bonded magnetic powder into a compact in a single-sided oriented magnetic field, wherein the single-sided oriented magnetic field means that in a die cavity of the pressing die, only one surface in the die cavity is provided with an oriented magnetic field; and
baking: baking the compact to obtain an asymmetric suction bonded magnet.

15. An asymmetric suction bonded magnet, which is manufactured by the manufacturing method for an asymmetric suction bonded magnet according to claim 14.

16. A magnet assembly, comprising the asymmetric suction bonded magnet according to claim 15.

17. The manufacturing method for an asymmetric suction magnet according to claim 2, wherein the magnetic powder has a particle size of 2.0 to 6.0 μm; and/or
before the pressing step, the method further comprises:
a step of manufacturing magnetic powder: melting raw materials into alloy according to the chemical components of the magnetic powder, and crushing and grinding the alloy into magnetic powder.

18. The manufacturing method for an asymmetric suction magnet according to claim 3, wherein the magnetic powder has a particle size of 2.0 to 6.0 μm; and/or
before the pressing step, the method further comprises:
a step of manufacturing magnetic powder: melting raw materials into alloy according to the chemical components of the magnetic powder, and crushing and grinding the alloy into magnetic powder.

19. The manufacturing method for an asymmetric suction magnet according to claim 4, wherein the magnetic powder has a particle size of 2.0 to 6.0 μm; and/or
before the pressing step, the method further comprises:
a step of manufacturing magnetic powder: melting raw materials into alloy according to the chemical components of the magnetic powder, and crushing and grinding the alloy into magnetic powder.

20. The manufacturing method for an asymmetric suction magnet according to claim 5, wherein the magnetic powder has a particle size of 2.0 to 6.0 μm; and/or
before the pressing step, the method further comprises:
a step of manufacturing magnetic powder: melting raw materials into alloy according to the chemical components of the magnetic powder, and crushing and grinding the alloy into magnetic powder.
